(19) United States
(12) Patent Application Publication
(10) Pub. No.: US 2008/0186408 A1
(43) Pub. Date: Aug. 7, 2008

(54) Broadcasting receiving apparatus

(75) Inventor: Shusuke Narita, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 12/068,085

(22) Filed: Feb. 1, 2008

(30) Foreign Application Priority Data
Feb. 2, 2007 (JP) 2007-023677

(51) Int. Cl. H04N 5/46

(52) U.S. Cl. 348/729; 348/E05.114

(57) ABSTRACT

A micro processing unit 11 of a digital broadcasting receiving apparatus is functionally equipped with a first intensity obtaining unit for setting an antenna connected to an antenna unit in a plurality of preset directions and obtaining reception intensity in each set direction, and an antenna judging unit for judging on the basis of the obtained reception intensity in each direction whether the connected antenna is a smart antenna or not, and judging on the basis of the obtained reception intensity in each direction whether the connected antenna is a bi directional antenna having directivities in two directions intersecting to each other at substantially 180 degree or a unidirectional antenna having directivity in only one direction when the connected antenna is judged as the smart antenna.

### BACKGROUND OF THE INVENTION

This application is based on Japanese Patent Application No. 2007-023677 filed on Feb. 2, 2007, and the contents of which are hereby incorporated by reference.

1. Field of the Invention

The present invention relates to a broadcasting receiving apparatus to which a smart antenna that is structured as an antenna changeable in directivity direction is connectable and which can receive television broadcast through the connected antenna and output the television broadcast onto a monitor.

2. Description of the Related Art

A directional antenna such as Yagi antenna or the like has been hitherto used to receive television broadcast. Such a directional antenna can receive even weak electric waves because of strong directivity, however, it has a drawback that it can receive only electric waves in a specific direction. Such a characteristic causes little problem in Japan or the like where transmission towers for transmitting television broadcasting waves concentrate in one place. However, United States of America or the like has many areas where a plurality of transmission towers are distributed so as to surround an urban area, thus when a directional antenna is used, there exists a station which cannot be received television broadcasting waves although it is near to a transmission tower.

Therefore, in order to solve such a problem, EIA (Electric Industries Alliance)—909 (=Antenna Control Interface) as a standard to control an antenna from a receiving apparatus has been constituted so that the directivity of the antenna can be changed. This is a standard for connecting a directivity changeable antenna (hereinafter referred to as “smart antenna”) to a receiving apparatus and control the antenna from the receiving apparatus side through a modular terminal.

In a television broadcasting receiving apparatus to which the smart antenna is connectable as described above, it is necessary to set a direction of the smart antenna along which a television broadcast signal can be received under the best state (hereinafter referred to as “optimum reception direction”), and various kinds of apparatus and methods for setting the optimum reception direction have been proposed.

For example, JP-A-2006-201285 discloses a TV broadcasting receiving apparatus that outputs a reception direction control signal for successively instructing all the reception directions to a connected antenna, measures the reception intensity of the television broadcast signal received when each reception direction is instructed and judges on the basis of the measured reception intensity whether the connected antenna is a smart antenna or not. According to the TV broadcasting receiving apparatus as described above, it can be judged whether the connected antenna is a smart antenna or not, and also proper reception control can be performed in accordance with whether the connected antenna is a smart antenna or not.

However, in the above described TV broadcasting receiving apparatus, the directivity of the connected smart antenna cannot be identified, thus there is a problem that much time is required for a process of setting the optimum reception direction. That is, when the connected smart antenna is a bidirectional antenna having directivity in two directions which are intersected to each other at substantially 180 degree, it is sufficient to obtain the reception intensity to set the optimum reception direction in each direction within a substantially 180 degree range. However, when it is unclear whether the connected smart antenna is a bidirectional antenna or not, it is required to obtain reception intensity to set the optimum reception direction in each direction within a substantially 360 degree range.

### SUMMARY OF THE INVENTION

The present invention has been implemented in view of the above described problem, and it is an object the present invention to provide a broadcasting receiving apparatus that can identify a type of a connected antenna (that is, to judge whether the connected antenna is a smart antenna or not and also whether the connected antenna is a bidirectional antenna or not).

In order to attain the above described object, a broadcasting receiving apparatus in accordance with the present invention is a broadcasting receiving apparatus to which a smart antenna as an antenna having a changeable directivity direction is connectable and which can receive television broadcast through the connected antenna and output the received television broadcast onto a monitor, includes: an intensity obtaining unit for setting the connected antenna to a plurality of preset directions and obtaining reception intensity for every set direction; a first judging unit for judging on the basis of the reception intensity in each direction obtained by the intensity obtaining unit whether the connected antenna is a smart antenna or not; and a second judging unit for judging on the basis of the reception intensity in each direction obtained by the intensity obtaining unit whether the connected antenna is a bidirectional antenna having directivity in two directions intersecting to each other at substantially 180 degree or a unidirectional antenna having directivity in only one direction when it is judged by the first judging unit that the connected antenna is a smart antenna.

According to this structure, the connected antenna is set to the plurality of preset directions, and the reception intensity in each set direction is obtained. On the basis of the obtained reception intensity in each direction, it is judged whether the connected antenna is the smart antenna or not. When it is judged that the connected antenna is the smart antenna, on the basis of the obtained reception intensity in each direction, it is judged whether the connected antenna is a bidirectional antenna having directivity in two direction intersecting to each other at substantially 180 degree or a unidirectional antenna having directivity in only one direction. Therefore, the type of the connected antenna (whether the connected antenna is the smart antenna or not and also whether the connected antenna is a bidirectional antenna or not) can be identified.

That is, it is judged whether the connected antenna is the bidirectional antenna having directivity in two direction intersecting to each other at substantially 180 degree or the unidirectional antenna having directivity in only one direction, thus it becomes possible that the optimum reception direction is efficiently determined.

Furthermore, in accordance with the present invention, the broadcasting receiving apparatus further includes: a channel setting unit for setting a prescribed channel for receiving through the connected antenna from a plurality of preset channels; and a channel judging unit for judging whether the prescribed channel set by the channel setting unit is a channel belonging to an UHF (Ultra High Frequency) band or a channel belonging to a VHF (Very High Frequency) band, and the apparatus is characterized by that the intensity obtaining unit makes the channel setting unit successively set one of the plurality of channels and obtains the reception intensity in each channel of the plurality of channels, and at least one of the first judging unit and the second judging unit sections the channels into a UHF band channel group and a VHF band channel group that respectively comprise channels judged as belonging to the UHF band and channels judged as belonging to the VHF band by the channel judging unit to make a judgment for every channel group in the broadcasting receiving apparatus structured as above described.

According to this structure, a prescribed channel which is contained in the plurality of preset channels and is received through the connected antenna is successively set, the reception intensity in each channel is obtained, and it is judged whether the set prescribed channel belongs to UHF band or the VHF band. The channels are sectioned into the channels judged as belonging to the UHF band and the channels judged as belonging to the VHF band, and at least one of the judgment as to whether the connected antenna is the smart antenna and the judgment as to whether the connected antenna is a bidirectional antenna is made. Therefore, the type of the connected antenna (=whether the smart antenna or not, and whether the bidirectional antenna or not) can be more accurately judged.

That is, at least one of whether the connected antenna is the smart antenna and whether the connected antenna is a bidirectional antenna is judged individually for each of the channel group comprising the channels judged as belonging to the UHF band and the channel group comprising the channels judged as belonging to the VHF band. At this point there is a case where the judgment result is different between a channel judged as belonging to the UHF band and a channel judged as belonging to the VHF band. Therefore, the type of the connected antenna (=at least one of the smart antenna or not and the bidirectional antenna or not) can be further accurately judged.

Furthermore, the broadcasting receiving apparatus in accordance with the present invention is characterized by that the intensity obtaining unit sets the connected antenna in four directions intersecting to one another at every 90 degree and obtains the reception intensity in each set direction, and at least one of the first judging unit and the second judging unit makes the judgment on the basis of the maximum reception intensity, the reception intensity in a direction intersecting to the maximum reception intensity obtaining direction at 90 degree and the reception intensity in a direction intersecting to the maximum reception intensity obtaining direction at 180 degree out of the reception intensities in the respective obtained directions by the intensity obtaining unit in the broadcasting receiving apparatus structured as above described.

According to the above described structure, the connected antenna is set in the four directions intersecting to one another at every 90 degree, and the reception intensity in each set direction is obtained. At least one of the judgment as to whether the connected antenna is the smart antenna or not and the judgment as to whether the connected antenna is a bidirectional antenna or not is made on the basis of the maximum reception intensity, the reception intensity in a direction intersecting to the maximum reception intensity obtaining direction at 90 degree and the reception intensity in a direction intersecting to the maximum reception intensity obtaining direction at 180 degree out of the reception intensities in the respective obtained directions. Therefore, the type of the connected antenna (=at least one of whether the connected antenna is the smart antenna or not and whether the connected antenna is a bidirectional antenna or not) can be simply and surely identified.

### BRIEF DESCRIPTION OF THE DRAWINGS

FIG. 1 is a block diagram to show an example of the structure of a digital broadcasting receiving apparatus in accordance with the present invention;

FIG. 2 is a block diagram to show an example of the structure of a main part of the digital broadcasting receiving apparatus in accordance with the present invention;

FIGS. 3A to 3C are tables to show an example of information stored in each of a channel storage unit, a judgment value storage unit and a setting direction storage unit;

FIGS. 4A to 4C are diagrams to show the setting direction of a smart antenna, and the directivities of a bidirectional antenna and a unidirectional antenna;

FIG. 5 is a flowchart to show an example of the operation of the digital broadcasting receiving apparatus (mainly MPU);

FIG. 6 is a detailed flowchart (first half part) to show an example of type identifying process executed in step S105 of the flowchart shown in FIG. 5;

FIG. 7 is a detailed flowchart (last half part) to show an example of the type identifying process executed in step S105 of the flowchart shown in FIG. 5;

FIG. 8 is a detailed flowchart to show an example of direction setting process B executed in step S111 of the flowchart shown in FIG. 5;

FIG. 9 is a detailed flowchart (first half part) to show an example of judgment value renewal process executed in step S319 of the flowchart shown in FIG. 8;

FIG. 10 is a detailed flowchart (last half part) to show an example of the judgment value renewal process executed in step S319 of the flowchart shown in FIG. 8;

FIG. 11 is a detailed flowchart to show an example of reception possibility judging process executed in step S115 of the flowchart shown FIG. 5;

FIG. 12 is a detailed flowchart to show an example of direction setting process B executed in step S119 of the flowchart shown in FIG. 5; and

FIG. 13 is a detailed flowchart to show an example of direction setting process C executed in step S121 of the flowchart shown in FIG. 5.

### DESCRIPTION OF THE PREFERRED EMBODIMENTS

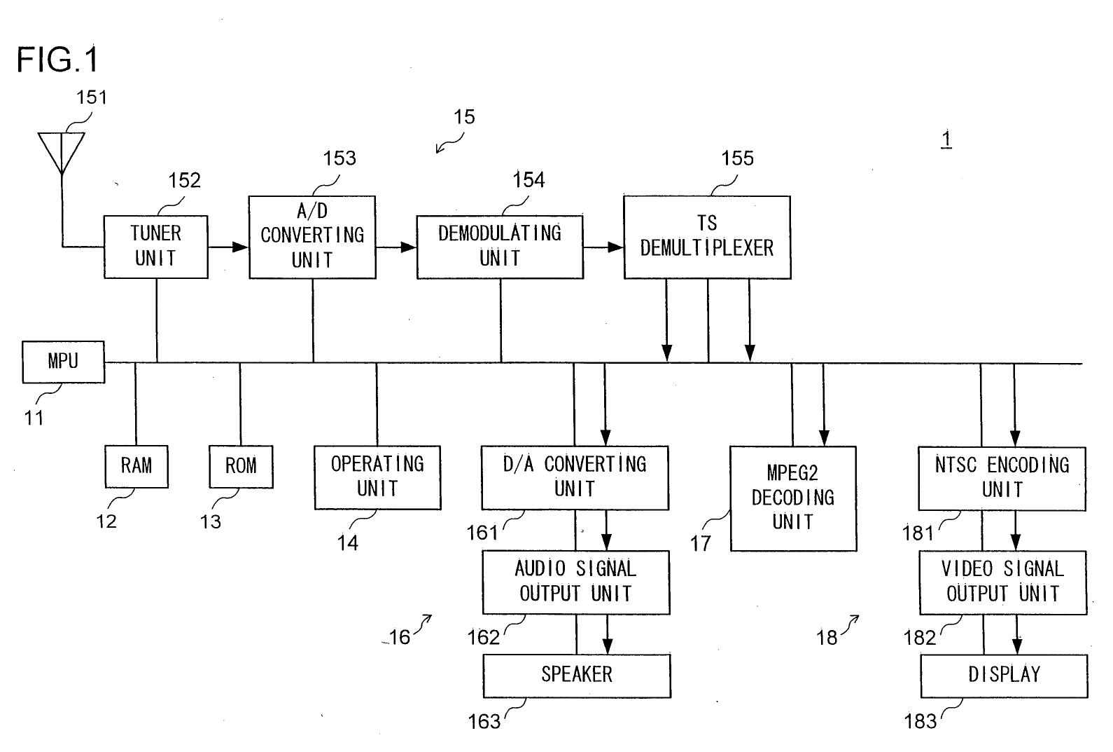

Hereinafter an embodiment of the present invention will be described with reference to the accompanying drawings. FIG. 1 is a block diagram to show an example of a structure of a digital broadcasting receiving apparatus in accordance with the present invention. The digital broadcasting receiver 1 (it corresponds to a broadcasting receiving apparatus) is a apparatus for receiving television broadcast and outputting the television broadcast to a display 183 and a speaker 163 which will be described later, and it is equipped with micro processing unit (MPU) 11, random access memory (RAM) 12, read only memory (ROM) 13, an operating unit 14, a receiving unit 15, a sound output unit 16, an MPEG2 decoding unit 17 and an image output unit 18.

The MPU 11 controls the overall operation of the digital broadcasting receiver 1. The RAM (Random Access Memory) 12 is a memory for storing information such as audio information, video information or the like while freely reading and writing these information. The ROM (Read Only Memory) 13 is a memory for storing a control program for operating the MPU 11 or the like to operate the MPU 11.

The operating unit 14 accepts various kinds of operations such as ON/OFF operation of a power source, tuning of channels or the like. The receiving unit 15 (it corresponds to a part of an intensity obtaining unit) receives and decodes television broadcast, and it is equipped with an antenna unit 151, a tuner unit 152, an A/D converting unit 153, a decoding unit 154 and a TS demultiplexer 155.

The antenna unit 151 is designed so that a smart antenna as an antenna whose directivity can be changed according to the EIA-909 standard can be connected to the antenna unit 151, and the antenna unit 151 receives television broadcast waves. The tuner unit 152 (it corresponds to a part of the channel setting unit) tunes broadcast of a preset channel from the television broadcast waves received by the antenna unit 151. The A/D converting unit 153 converts an output signal (=analog signal) from the tuner unit 152 to digital information. The decoding unit 154 decodes the output information from the A/D converting unit 153. The TS (Transport Stream) demultiplexer 155 separates the output information demodulated by the demodulating unit 154 by every type (=video information, audio information, control information or the like) to output.

The sound output unit 16 outputs the sound corresponding to one television broadcast received by the receiving unit 15, and it is equipped with a D/A converting unit 161, an audio signal output unit 162 and a speaker 163. The D/A converting unit 161 converts audio information (=digital information) output from the TS demultiplexer 155 to an analog signal. The audio signal output unit 162 outputs an audio signal which is converted to an analog signal by the D/A converting unit 161. The speaker 163 outputs the sound corresponding to the audio signal output from the audio signal output unit 162.

The MPEG (Motion Picture Experts Group) 2 decoding unit 17 decodes the video information output from the TS demultiplexer 155 to video information before compression.

The image output unit 18 outputs the video information decoded by the MPEG2 decoding unit 17, and it is equipped with an NTSC encoding unit 181, a video signal output unit 182, and a display 183. The NTSC (National Television Standards Committee) encoding unit 181 converts the video information decoded by the MPEG2 decoding unit 17 to a television signal of the NTSC system. The video signal output unit 182 outputs the television signal of the NTSC system output from the NTSC encoding unit 181 to the display 183. The display 183 (it corresponds to a monitor) is equipped with LCD (Liquid Crystal Display), PDP (Plasma Display Panel) or the like, and displays pictures corresponding to the television signal output from the video signal output unit 182.

Next, the operation when the digital broadcasting receiver 1 receives broadcast will be described. First, transmitted digital broadcast waves are received by the antenna unit 151. When a channel tuning operation is accepted through the operating unit 14, switching of a transponder to be received is performed by the tuner unit 152. The received digital broadcast waves are converted to digital information by the A/D converting unit 153, and demodulated by the demodulating unit 154.

The digital broadcast waves are transmitted as a TS (Transport Stream) packet from the transmission side (transmission station). This TS packet comprises video information, audio information, control information and the like, and these information are separated and output by the TS demultiplexer 155, and stored in the RAM 12. The audio information read out from the RAM 12 is converted to an analog signal by the D/A converting unit 161, and sounds are output from the speaker 163 through the audio signal output unit 162.

Furthermore, the video information read out from the RAM 12 is decoded to the video information before compression by the MPEG2 decoding unit 17 and converted to the television signal of the NTSC system by the NTSC encoding unit 181, and then the pictures are displayed on the display 183 through the video signal output unit 182.

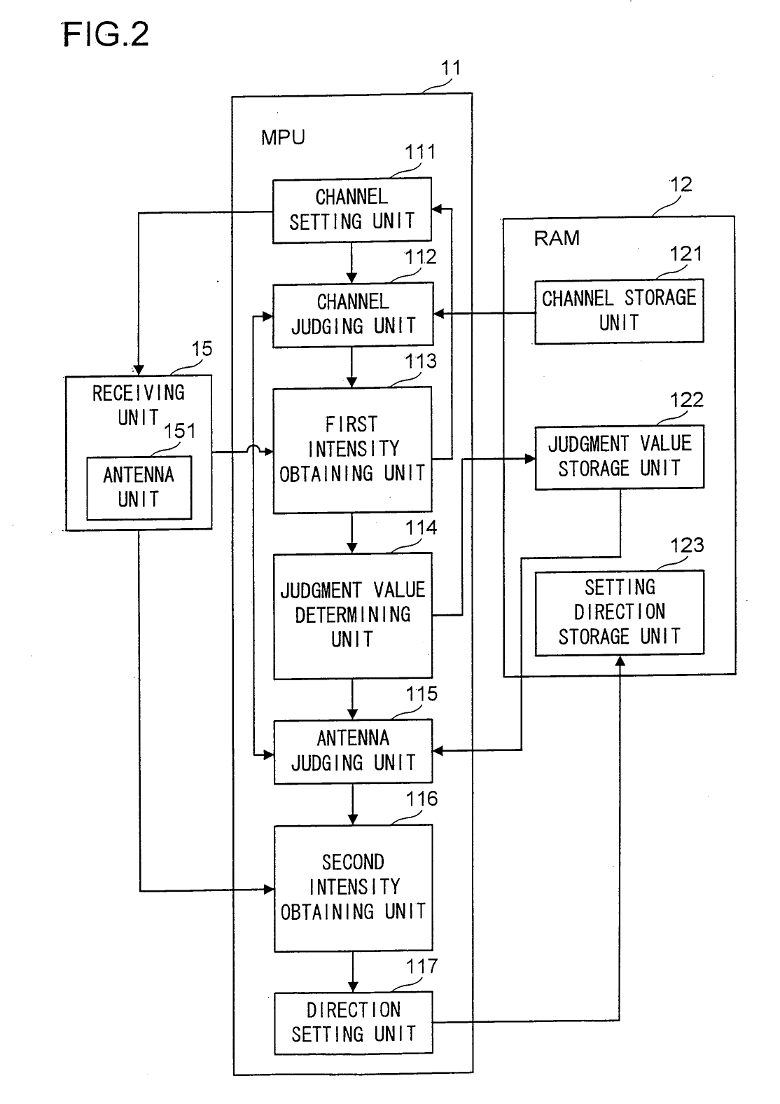

FIG. 2 is a block diagram to show an example of the structure of a main part in the digital broadcasting receiver 1 in accordance with the present invention. The MPU 11 of the digital broadcasting receiver 1 shown in FIG. 1 is functionally equipped with a channel setting unit 111, a channel judging unit 112, a first intensity obtaining unit 113, a judgment value determining unit 114, an antenna judging unit 115, a second intensity obtaining unit 116 and a direction setting unit 117. The RAM 12 is functionally equipped with a channel storage unit 121, a judgment value storage unit 122 and a setting direction storage unit 123.

In this case, the MPU 11 reads out and executes the control program stored in the ROM 13 shown in FIG. 1 or the like in advance, thereby functioning as function parts such as the channel setting unit 111, the channel judging unit 112, the first intensity obtaining unit 113, the judgment value determining unit 114, the antenna judging unit 115, the second intensity obtaining unit 116, the direction setting unit 117 and the like, and also the RAM 12 is made to function as function parts such as the channel storage unit 121, the judgment value storage unit 122, the setting direction storage unit 123 and the like.

Furthermore, data which can be stored in a detachably mounted recording medium out of various kinds of data stored in the RAM 12, the ROM 13 shown in FIG. 1 may be read out by a driver such as a hard disk drive, an optical disc drive, a flexible disk drive, a silicon disk drive, a cassette medium reading machine or the like. In this case, the recording medium may be a hard disk, an optical disc, a flexible disk, CD (Compact Disc), DVD (Digital Versatile Disc), a semiconductor memory or the like.

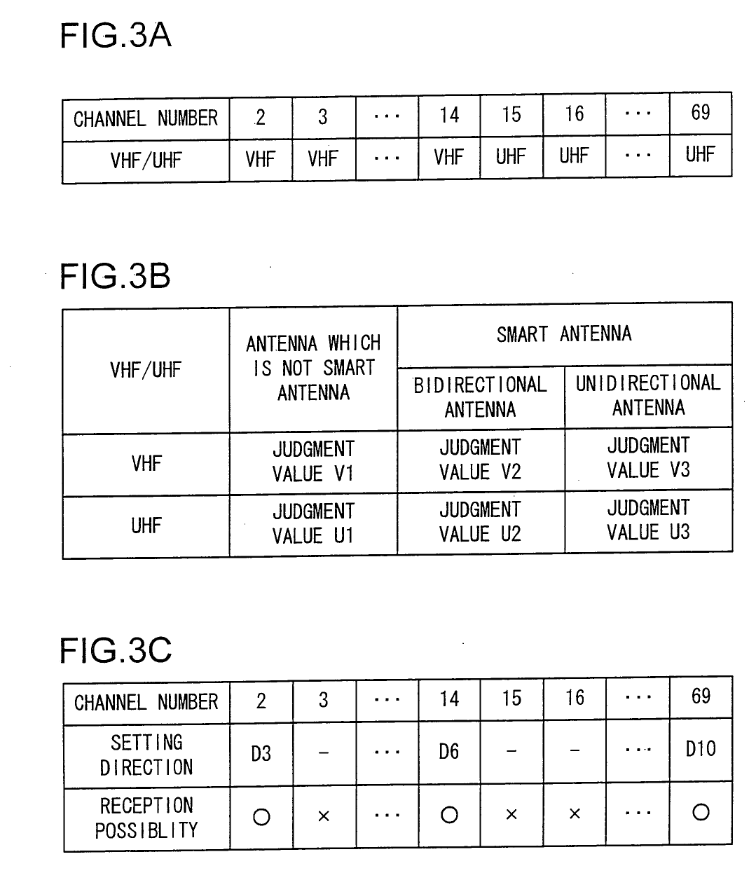

The channel storage unit 121 (it corresponds to a part of the channel judging unit) is a function part for storing information (hereinafter referred to as frequency identification information) representing whether each of preset a plurality of channels is a channel belonging to the UHF (Ultra High Frequency) band or a channel belonging to the VHF (Very High Frequency) band (see FIG. 3A).

The judgment value storage unit 122 (it corresponds to a part of the first judging unit, a part of the second judging unit) is a function part for storing judgment values V1 to V3, U1 to U3 which are determined by the judgment value determining unit 114 and used to judge the type of the antenna (=whether the antenna is the smart antenna or not and whether the antenna is a bidirectional antenna or not) by the antenna judging unit 115 (see FIG. 3B).

The setting direction storage unit 123 is a function part for storing reception possibility information which is judged by the direction setting unit 117 and represents whether the reception is possible or impossible, and information representing the set optimum reception direction (=the direction of the smart antenna in which the television broadcast signal can be received most excellently) for every plurality of preset channels (see FIG. 3C).

FIG. 3A-3C are tables to show an example of the information stored in the channel storage unit 121, the judgment value storage unit 122 and the setting direction storage unit 123, respectively. FIG. 3A is a table to show an example of the information stored in the channel storage unit 121. In this case, the information (=frequency identifying information) representing whether the channel is a channel belonging to the UHF band or a channel belonging to the VHF channel is stored in association with the channel number. For example, the channels whose channel numbers are “2” to “14” are channels belonging to the VHF band, and the channels whose channel numbers are “15” to “69” are channels belonging to the UHF band.

FIG. 3B is a table to show an example of the information stored in the judgment value storage unit 122. In this case, the judgment value V1 is a judgment value representing that the antenna connected to the antenna unit 151 is not the smart antenna in the channels belonging to the VHF band, and the judgment value V2 is a judgment value representing that the antenna connected to the antenna unit 151 is the smart antenna and also a bidirectional antenna in the channels belonging to the VHF band. The judgment value V3 is a judgment value representing that the antenna connected to the antenna unit 151 is the smart antenna and also unidirectional antenna in the channels belonging to the VHF band.

Furthermore, the judgment value U1 is a judgment value representing that the antenna connected to the antenna unit 151 is not the smart antenna in the channels belonging to the UHF band, and the judgment value U2 is a judgment value representing that the antenna connected to the antenna unit 151 is the smart antenna and also bidirectional antenna in the channels belonging to the UHF band. The judgment value U3 is a judgment value representing that the antenna connected to the antenna unit 151 is the smart antenna and also unidirectional antenna in the channels belonging to the UHF band.

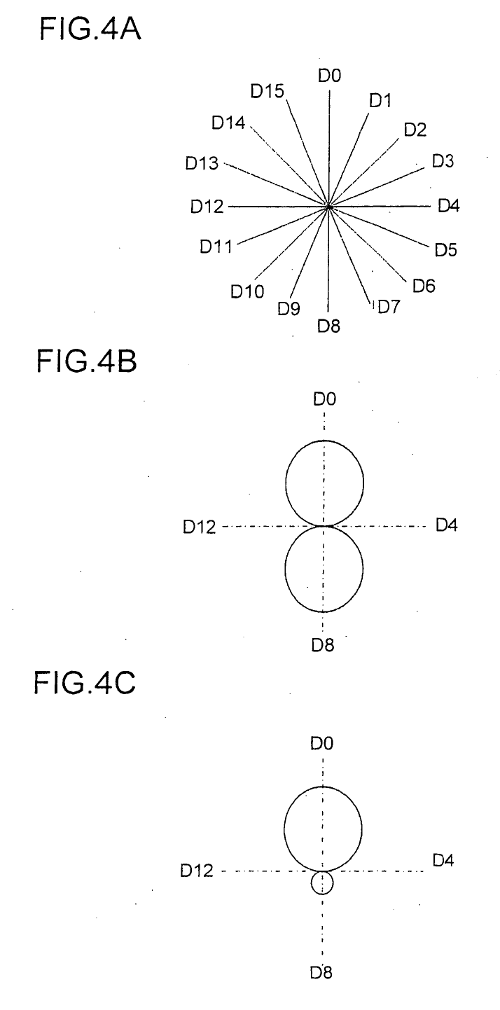

FIG. 3C is a table to show an example of the information stored in the setting direction storage unit 123. In this case, the information representing the optimum reception direction set by the direction setting unit 117 and the information representing whether the reception is possible or impossible are stored in association with the channel number. For example, the channel whose channel number is “2” is set to a receivable state, and the optimum reception direction is a direction D3 (see FIG. 4A). Furthermore, the channel whose channel number is “3” is set to a non receivable state.

The functional structure of the MPU 11 will be described again with reference to FIG. 2. According to the instruction from the first intensity obtaining unit 113 and the second intensity obtaining unit 116, through the receiving unit 15 (the tuner unit 152), the channel setting unit 111 (it corresponds to a part of the channel setting unit) sets a prescribed channel which is contained in the plurality of preset channels and is received through the connected antenna.

The channel judging unit 112 (it corresponds to a part of the channel judging unit) is a function part for judging whether a prescribed channel set by the channel setting unit 111 is a channel belonging to the UHF band or a channel belonging to the VHF band. To be more concrete, the channel judging unit 112 reads out from the channel storage unit 121 the frequency identification information corresponding to the channel number of a prescribed channel set by the channel setting unit 111 (=information representing whether the channel being noted is a channel belonging to the UHF band or a channel belonging to the VHF band), thereby judging whether the set prescribed channel is a channel belonging to the UHF band or a channel belonging to the VHF band.

The first intensity obtaining unit 113 (it corresponds to a part of the intensity obtaining unit) is a function part of making the channel setting unit 111 successively set a plurality of channels until the type of the antenna (=the smart antenna or not, and a bidirectional antenna or not) is judged by the antenna judging unit 115, and also setting the antenna connected to the antenna unit 151 in a plurality of preset directions for every channel to obtain the reception intensity for every set direction through the receiving unit 15. In this case, a bit error rate (BER: Bit Error Rate) is used as the reception intensity. That is, this indicates that the reception intensity is weaker as the value of BER is larger.

FIGS. 4A to 4C are diagrams to show the setting direction of the smart antenna, and the directivities of the bidirectional antenna and the unidirectional antenna. FIG. 4A is a diagram to show the direction of the antenna set by the first intensity obtaining unit 113 and the second intensity obtaining unit 116. As shown in FIG. 4A, the antenna connected to the antenna unit 151 is set to any direction of sixteen directions D0 to D15 which intersect to one another at every 22.5 degree.

FIG. 4B is a diagram to show the directivity of the bidirectional antenna. The bidirectional antenna is an antenna having directivities in two directions (in this case, two directions of direction D0 and direction D8) which intersect to each other at substantially 180 degree. FIG. 4C is a diagram to show the directivity of the unidirectional antenna. The unidirectional antenna is an antenna having the directivity in only one direction (in this case, the direction of the direction D0).

The functional structure of the MPU 11 will be described again with reference to FIG. 2. On the basis of the reception intensity for every direction obtained by the first intensity obtaining unit 113, the judgment value determining unit 114 (it corresponds to a part of the first judging unit, and a part of the second judging unit) calculates judgment values V1 to V3, U1 to U3 (see FIG. 3B) for judging whether the antenna connected to the antenna unit 151 is the smart antenna or not and also whether the antenna connected to the antenna unit 151 is a bidirectional antenna or unidirectional antenna, and stores these calculated values into the judgment value storage unit 122.

Furthermore, the judgment value determining unit 114 calculates the judgment values V1 to V3, U1 to U3 for the channels while the channels are sectioned to the channels judged as belonging to the UHF band and the channels judged as belonging to the VHF band by the channel judging unit 112. In addition, the judgment value determining unit 114 determines the maximum reception intensity (in this case, the minimum BER), the reception intensity in a direction intersecting to the direction providing the maximum reception intensity at 90 degree, the reception intensity in a direction intersecting to the direction providing the maximum reception intensity at 180 degree, and the judgment values V1 to V3, U1 to U3.

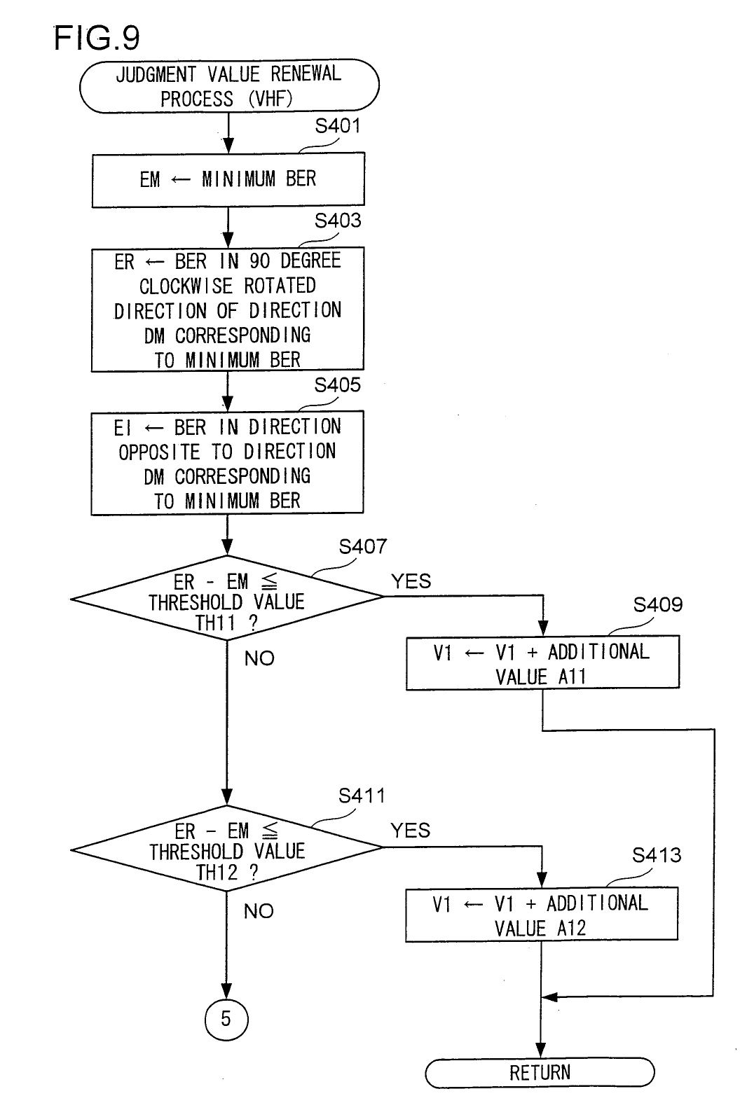

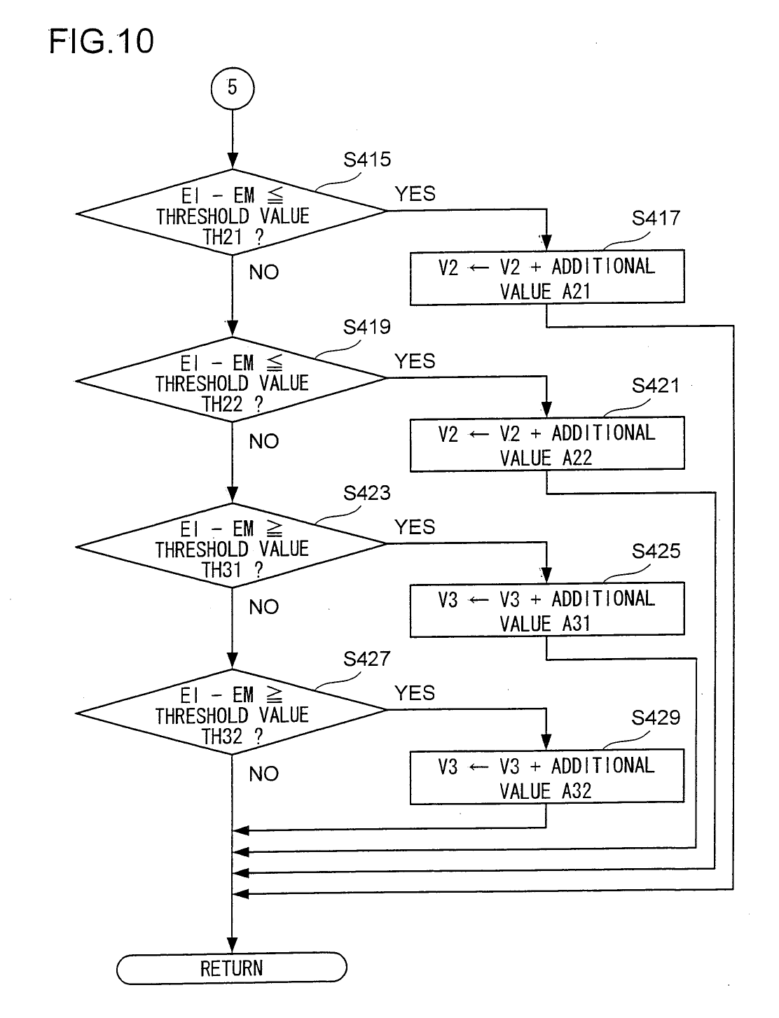

Specifically, the judgment value determining unit 114 calculates the judgment values V1 to V3, U1 to U3 according to the following method (see the flowchart shown in FIGS. 9 and 10). In this case, for convenience of description, it is assumed that the channel set by the channel setting unit 111 is a channel belonging to the VHF band. First, “0” is set as an initial values of the judgment values V1 to V3. The value of the minimum BER is set to a parameter EM, the value of BER in the direction obtained by clockwise rotating the direction corresponding to the minimum BER by 90 degree is set to a parameter ER, and the value of BER in the direction opposite to the direction corresponding to the minimum BER is set to a parameter EI. Subsequently, when the difference between the parameter ER and the parameter EM is not more than predetermined threshold values TH11, TH12, preset positive additional values A11, A12 are added to the judgment value V1.

When the difference between the parameter EI and the parameter EM is not more than predetermined threshold values TH21, TH22, preset positive additional values A21, A22 are added to the judgment value V2. Furthermore, when the difference between the parameter EI and the parameter EM is not less than predetermined threshold values TH31, TH32, preset positive additional values A31, A32 are added to the judgment V3.

That is, the judgment value determining unit 114 adds the judgment value V1 representing that the antenna is not the smart antenna when the difference between the minimum BER value and the value of BER in the direction which is clockwise rotated from the direction corresponding to the minimum BER by 90 degree is small. Furthermore, the judgment value determining unit 114 adds the judgment value V2 representing that the antenna is a bidirectional antenna when the difference between the minimum BER value and the BER value in the direction opposite to the direction corresponding to the minimum BER is small. Still further, the judgment value determining unit 114 adds the judgment value V3 representing that the antenna is a unidirectional antenna when the difference between the minimum BER value and the BER value in the direction opposite to the direction corresponding to the minimum BER is large.

The antenna judging unit 115 (it corresponds to a part of the first judging unit, a part of the second judging unit) is a function part for judging on the basis of the judgment values V1 to V3, U1 to U3 stored in the judgment value storage unit 122 whether the antenna connected to the antenna unit 151 is the smart antenna or not and also whether the antenna connected to the antenna unit 151 is a bidirectional antenna or unidirectional antenna.

Furthermore, the channels are sectioned to a channel group of channels judged as belonging to the UHF band and a channel group of channels judged as belonging to the VHF band by the channel judging unit 112, and the antenna judging unit 115 judges for every channel group whether the antenna is the smart antenna or not and whether the channel is a bidirectional antenna or unidirectional antenna.

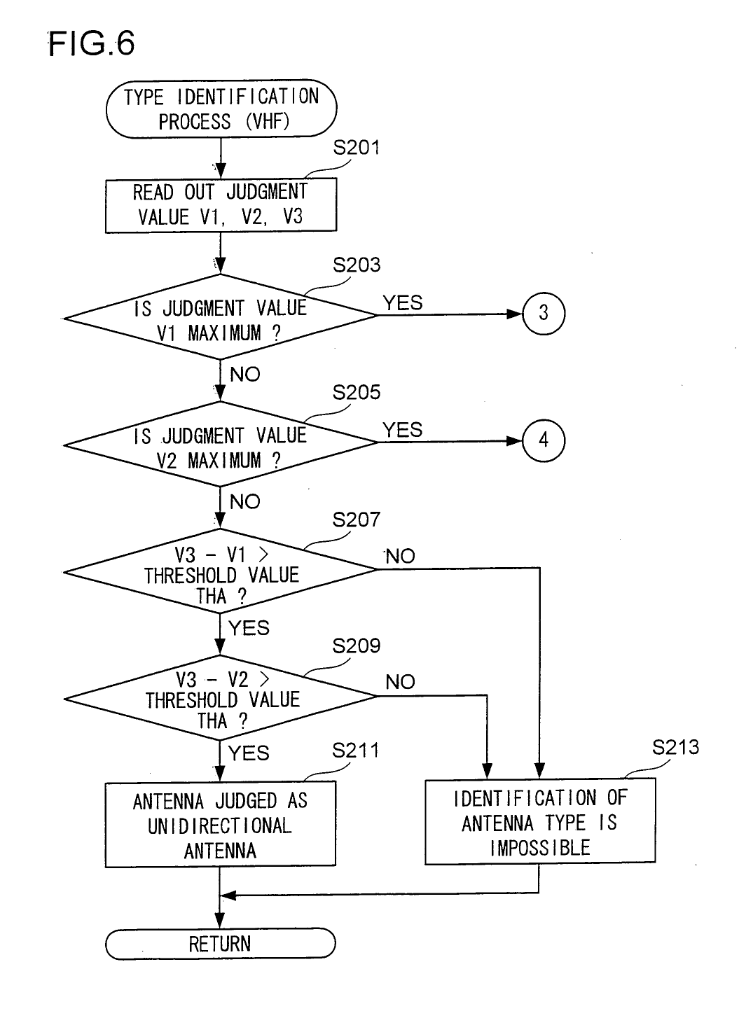

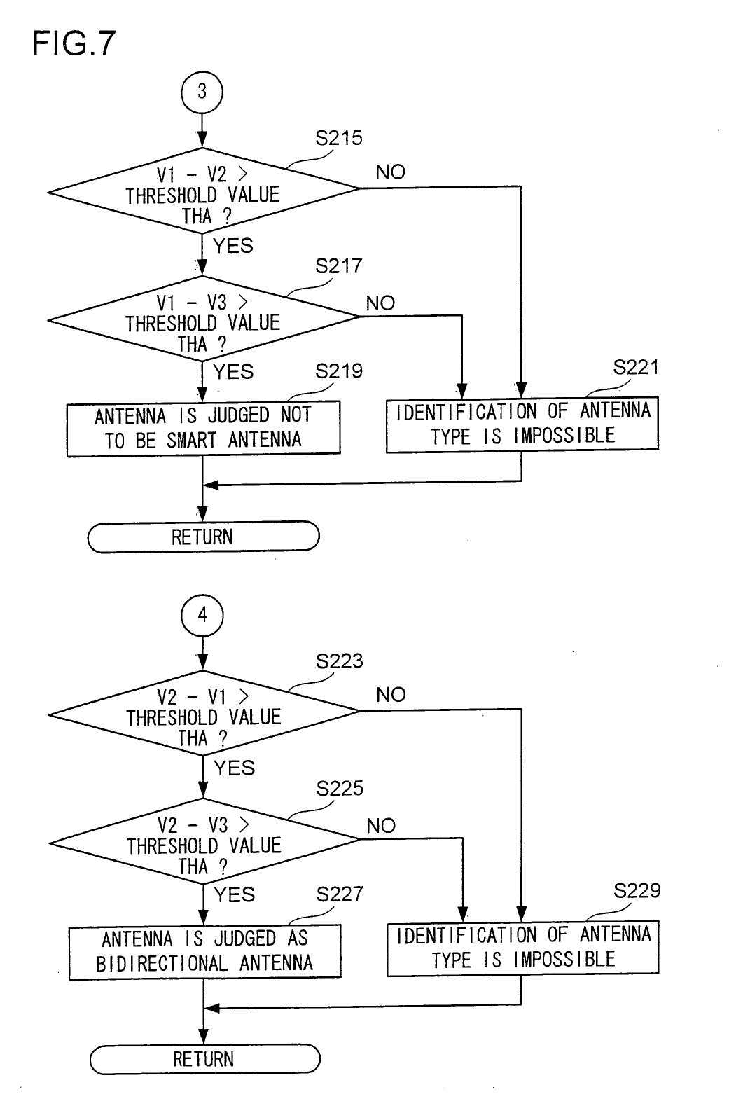

Specifically, the antenna judging unit 115 judges that the antenna is not the smart antenna when both the values obtained by subtracting the judgment values V2, V3 from the judgment value V1 are larger than a predetermined threshold value THA, judges that the antenna is the smart antenna and also a bidirectional antenna when both the values obtained by subtracting the judgment values V1, V3 from the judgment V2 are larger than the predetermined threshold value THA, and judges that the antenna is the smart antenna and also a unidirectional antenna when both the values obtained by subtracting the judgment values V1, V2 from the judgment value V3 are larger than the predetermined threshold value THA (see the flowchart shown in FIGS. 6 and 7).

The second intensity obtaining unit 116 is a function part for making the channel setting unit 111 set prescribed channel out of the plurality of channels, setting the antenna connected to the antenna unit 151 in predetermined a plurality of directions only when the antenna connected to the antenna unit 151 is judged to be the smart antenna by the antenna judging unit 115, and obtaining the reception intensity for every set direction. That is, the second intensity obtaining unit 116 obtains reception intensity only once when it is judged by the antenna judging unit 115 whether the antenna connected to the antenna unit 151 is not the smart antenna.

When it is judged by the antenna judging unit 115 that the antenna is a bidirectional antenna, the second intensity obtaining unit 116 sets the connected antenna in eight directions (directions D0 to D7) intersecting to one another at every 22.5 degree between a preset one direction and the direction intersecting to the one direction concerned at an angle of 180 degree, and obtains the reception intensity for every set direction. Furthermore, when it is judged by the antenna judging unit 115 that the connected antenna is a unidirectional antenna, the second intensity obtaining unit 116 sets the connected antenna in sixteen directions (directions D0 to D15) intersecting to one another at every 22.5 degree between the preset one direction and the direction intersecting to the one direction at an angle of 360 degree, and obtains the reception intensity for every set direction.

The direction setting unit 117 is a functional part for setting the optimum reception direction of the antenna connected to the antenna unit 151 to the direction of the maximum reception intensity out of the reception intensities obtained by the first intensity obtaining unit 113 and the second intensity obtaining unit 116, and storing the set direction into the setting direction storage unit 123. However, when the maximum reception intensity is not more than a predetermined threshold value, the direction setting unit 117 stores into the setting direction storage unit 123 the information indicating the reception is impossible.

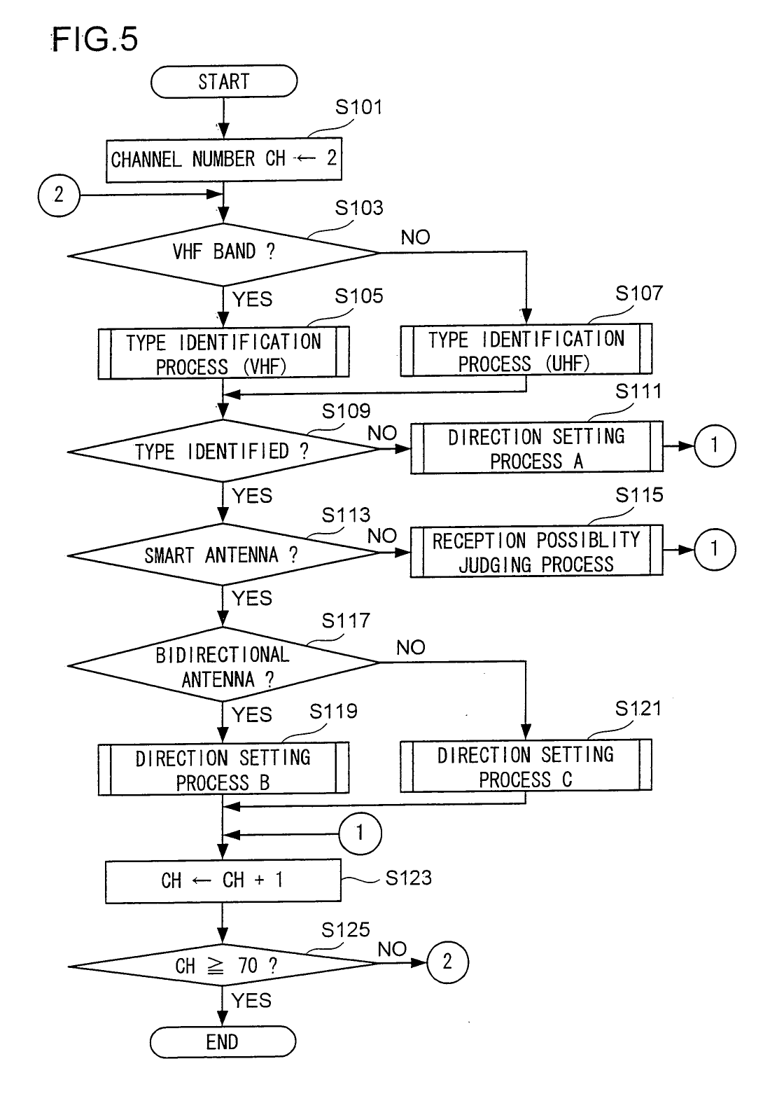

FIG. 5 is a flowchart to show an example of the operation of the digital broadcasting receiving apparatus (mainly MPU 11). First, the channel number CH is set to “2” by the channel setting unit 111 (S101). Then, it is judged by the channel judging unit 112 whether the channel corresponding to the channel number set in strep S101 is a channel belonging to the VHF band (S103).

If it is judged that the channel concerned belongs to the VHF band (Yes in S103), the type identifying process (VHF) as the process of identifying the type of the antenna connected to the antenna unit 151 (=the smart antenna or not, and a bidirectional antenna or not) is executed by the antenna judging unit 115 (S105). If it is judged that the channel is not a channel belonging to the VHF band (=a channel belonging to the UHF band) (NO in S103), the type identifying process (UHF) as the process of identifying the type of the antenna connected to the antenna unit 151 (=the smart antenna or not, and a bidirectional antenna or not) is executed by the antenna judging unit 115 (S107).

When the process of step S105 is finished or when the process of step S107 is finished, it is judged by the first intensity obtaining unit 113 whether the identification of the type of the antenna connected to the antenna unit 151 is completed (S109). If it is judged that the identification of the type of the antenna is not completed (No in S109), the first intensity obtaining unit 113 and the judgment value determining unit 114 executes the direction setting process A as the process of renewing the judgment value and setting the optimum reception direction (S111), and then the process goes to the step S123.

If it is judged that the identification of the type of the antenna is completed (YES in S109), the second intensity obtaining unit 116 judges whether it is judged in step S105 or step S107 that the antenna is the smart antenna (S113). If it is judged that the antenna is not the smart antenna (NO in S113), the second intensity obtaining unit 116 and the direction setting unit 117 executes the reception possibility judging process as the process of judging whether the reception is possible or impossible (S115), and then the process goes to the step S123.

When the antenna is judged as the smart antenna (YES in S113), the second intensity obtaining unit 116 judges whether it is judged in step S105 or step S107 that the antenna is a bidirectional antenna (S117). If it is judged that the antenna is a bidirectional antenna (NO in S117), the second intensity obtaining unit 116 and the direction setting unit 117 executes the direction setting process B as the process of setting the optimum reception direction of the bidirectional antenna (S119), and then the process goes to the step S123. If it is judged that the antenna is not a bidirectional antenna (=the antenna is a unidirectional antenna) (NO in S117), the second intensity obtaining unit 116 and the direction setting unit 117 executes the direction setting process C as the process of setting the optimum reception direction of the unidirectional antenna (S121), and then the process goes to the step S123.

When the process of step S111, step S115, step S119 or step S121 is finished, the channel setting unit 111 increments the channel number CH by only 1 (S123), and it is judged whether the channel number CH is equal to “70” or more (S125). If it is judged that the channel number CH is not above “70” (=“69” or less) (NO in S125), the process returns to step S103, and the process subsequent the step S103 is repetitively executed. If it is judged that the channel number CH is equal to “70” or more (YES in S125), the process is finished.

FIGS. 6 and 7 are detailed flowcharts to show an example of the type identification process executed in the step S105 of the flowchart shown in FIG. 5. In this case, for convenience of description, the type identification process (VHF) executed in step S105 will be described. In the flowchart of the type identification process (UHF) executed in step S107, the judgment values V1 to V3 in the flowchart of the type identification process (VHF) are replaced by the judgment values U1 to U3. All the following process is executed by the antenna judging unit 115.

The judgment values V1 to V3 are read out from the judgment value storage unit 122 (S201). Then, it is judged whether the judgment value V1 out of the judgment values V1 to V3 is maximum or not (S203). If it is judged that the judgment value V1 is maximum (YES in S203), the process goes to step S215 shown in FIG. 7. If it is judged that the judgment value V1 is not maximum (NO in step S203), it is judged whether the judgment value V2 out of the judgment values V1 to V3 is maximum or not (S205). If it is judged that the judgment value V2 is maximum (YES in S205), the process goes to step S223 shown in FIG. 7.

If it is judged that the judgment value V2 is not maximum (NO in S205), it is judged whether the difference value obtained by subtracting the judgment value V1 from the judgment value V3 is larger than a preset threshold value THA (S207). If it is judged that the value concerned is not more than the threshold value THA (NO in S207), it is judged the identification of the type of the antenna is impossible (S213), and the process is returned. If it is judged that the value concerned is larger than the threshold value THA (YES in S207), it is judged whether the difference value obtained by subtracting the judgment value V2 from the judgment value V3 is larger than the preset threshold value THA (S209). If it is judged that the value concerned is not more than the threshold value THA (NO in S209), it is judged that the identification of the type of the antenna is impossible (S213), and the process is returned. If it is judged that the value concerned is larger than the threshold value THA (YES in S209), it is judged that the antenna is the smart antenna and also a unidirectional antenna (S211), and the process is returned.

In the case of “YES” in step S203, it is judged whether the difference value obtained by subtracting the judgment value V2 from the judgment value V1 is larger than the preset threshold value THA (S215) as shown in FIG. 7. If it is judged that the difference value is not more than the threshold value THA (NO in S215), the identification of the type of the antenna is judged to be impossible (S221), and the process is returned. If the difference value is judged to be larger than the threshold value THA (YES in S215), it is judged whether the difference value obtained by subtracting the judgment value V3 from the judgment value V1 is larger than the preset threshold value THA (S217). If it is judged that the difference value is not more than the threshold value THA (NO in S217), it is judged that the identification of the type of the antenna is impossible (S221), and the process is returned. If it is judged that the difference value is larger than the threshold value THA (YES in S217), it is judged that the antenna is not the smart antenna (S219), and the process is returned.

In the case of “YES” in step S205, it is judged whether the difference value obtained by subtracting the judgment value V1 from the judgment value V2 is larger than the preset threshold value THA (S223) as shown in FIG. 7. If it is judged that the difference value is not more than the threshold value THA (NO in S223), it is judged that the identification of the type of the antenna is impossible (S229), and the process is returned. If it is judged that the difference value is larger than the threshold value THA (YES in S223), it is judged whether the difference value obtained by subtracting the judgment value V3 from the judgment V2 is larger than the preset threshold value THA (S225). If it is judged that the difference value is not more than the threshold value THA (NO in S225), it is judged that the identification of the type of the antenna is impossible (S229), and the process is returned. If it is judged whether the difference value is larger than the threshold value THA (YES in S225), it is judged that the antenna is the smart antenna and also a bidirectional antenna (S227), and the process is returned.

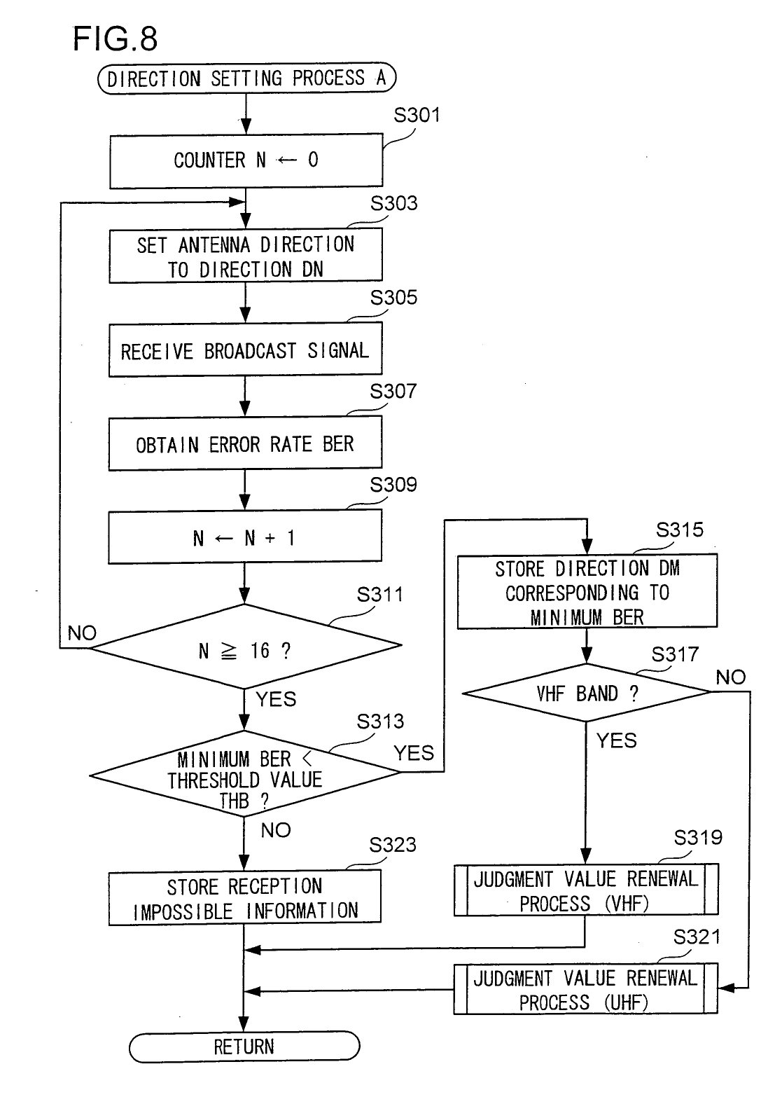

FIG. 8 is a detailed flowchart to show an example of the direction setting process A executed in step S111 of the flowchart shown in FIG. 5. First, a counter N for counting the direction of the antenna is set to an initial value “0” by the first intensity obtaining unit 113 (S301). Then, the direction of the antenna connected to the antenna unit 151 is set to a direction DN (in this case, N represents any value of 0 to 15=the value of the counter N) by the first intensity obtaining unit 113 (S303). Subsequently, the first intensity obtaining unit 113 receives the broadcast signal through the receiving unit 15 (S305). Subsequently, the first intensity obtaining unit 113 obtains a bit error rate BER (S307). Then, the first intensity obtaining unit 113 increments the value of the counter N by only 1 (S309), and it is judged whether the value of the counter N is equal to 16 or more (S311). If it is judged that the value of the counter N is not above 16 (=equal to 15 or less) (NO in S311), the process is returned to step S303, and the process of the step S303 and the subsequent steps is repetitively executed.

When it is judged that the value of the counter N is equal to 16 or more (YES in S311), the direction setting unit 117 judges whether the minimum bit error rate BER out of the 16 bit error rates BER obtained in step S307 is less than a preset predetermined threshold value THB (S313). If it is judged that the minimum bit error rate BER is equal to the threshold value THB or more (NO in S313), the direction setting unit 117 judges that the reception is impossible, information indicating that the reception is impossible is stored in the setting direction storage unit 123 (S323), and then the process is returned. If it is judged that the minimum bit error rate BER is not more than the threshold value THB (YES in S313), the information indicating that the reception is possible and the direction DM corresponding to the minimum bit error rate BER (any value of M=0 to 15) are stored in the setting direction storage unit 123 by the direction setting unit 117 (S315).

The channel judging unit 112 judges whether the channel of the channel number CH set in step S101 or step S123 shown in FIG. 5 is a channel belonging to the VHF band or not (S317). If it is judged that the channel concerned is a channel belonging to the VHF band (YES in S317), the judgment value determining unit 114 executes the judgment value renewal process (VHF) as the process of renewing the judgment values V1 to V3 stored in the judgment value storage unit 122 (S319), and then the process is returned. If it is judged that the channel concerned is not a channel belonging to the VHF band (=the channel concerned is a channel belonging to the UHF band) (NO in S317), the judgment value determining unit 114 executes the judgment value renewal process (UHF) as the process of renewing the judgment values U1 to U3 stored in the judgment value storage unit 122 (S321), and then the process is returned.

FIGS. 9 and 10 are detailed flowcharts to show an example of the judgment value renewing process executed in step S319 of the flowchart shown in FIG. 8. In this case, for convenience of description, the judgment value renewal process (VHF) executed in step S319 will be described, and the flowchart of the judgment value renewal process (UHF) executed in step S321 is a flowchart obtained by replacing the judgment values V1 to V3 of the flowchart of the judgment value renewal process (VHF) with the judgment values U1 to U3. All the following process is executed by the judgment value determining unit 114.

First, the value of the minimum bit error rate BER is set to the parameter EM (S401). The value of the bit error rate BER in the direction obtained by clockwise rotating the direction DM corresponding to the minimum bit error rate BER by 90 degree is set to a parameter ER (S403). Subsequently, the value of the bit error rate BER in the direction opposite to the direction DM corresponding to the minimum bit error rate BER is set to the parameter EI (S405). Subsequently, it is judged whether the difference value obtained by subtracting the parameter ER from the parameter EI is not more than a preset positive threshold value TH11 (S407). If it is judged that the difference value is not more than the threshold value TH11 (YES in S407), the judgment value V1 is added with a preset positive additional value A11 (for example, 2) (S409), and then the process is returned.

If it is judged that the difference value is not equal to the threshold value TH11 or less (NO in S407), the difference value obtained by subtracting the parameter ER from the parameter EI is not more than a preset positive threshold value TH12 larger than the threshold value TH11 (S411). If it is judged that the difference value is not more than the threshold value TH12 (YES in S411), the judgment value V1 is added with a positive additional value A12 (for example, 1) smaller than the preset additional value A11, and then the process is returned.

If it is judged that the difference value is not equal to the threshold value TH12 or less (NO in S411), it is judged whether the difference value obtained by subtracting the parameter EM form the parameter EI is not more than the preset positive threshold value TH21 (S415) as shown in FIG. 10. If it is judged that the difference value is not more than the threshold value TH21 (YES in S415), the judgment value V2 is added with a preset positive additional value A21 (for example, 2) (S417), and then the process is returned.

If it is judged that the difference value is not equal to the threshold value TH21 or less (NO in S415), it is judged whether the difference value obtained by subtracting the parameter EM from the parameter EI is not more than a positive threshold value TH22 larger than the preset threshold value TH21 (S419). If it is judged the difference value is not more than the threshold value TH22 (YES in S419), the judgment value V2 is added with a positive additional value A22 (for example, 1) smaller than the preset additional value A21 (S421), and then the process is returned.

If it is judged that the difference value is not equal to the threshold value TH22 or less (NO in S421), it is judged whether the difference value obtained by subtracting the parameter EM from the parameter EI is not less than a preset positive threshold value TH31 (S423). If it is judged that the difference value is not less than the threshold value TH31 (YES in S423), the judgment value V3 is added with a preset positive additional value A31 (for example, 2) (S425), and then the process is returned.

If it is judged that the difference value is not equal to the threshold value TH31 or more (NO in S423), it is judged whether the difference value obtained by subtracting the parameter EM from the parameter EI is not more than a positive threshold value TH32 smaller than the preset threshold value TH31 (S427). If it is judged that the difference value is not more than the threshold value TH32 (YES in S427), the judgment value V3 is added with a positive additional value A32 (for example, 1) smaller than the preset additional value A31 (S429), and then the process is returned.

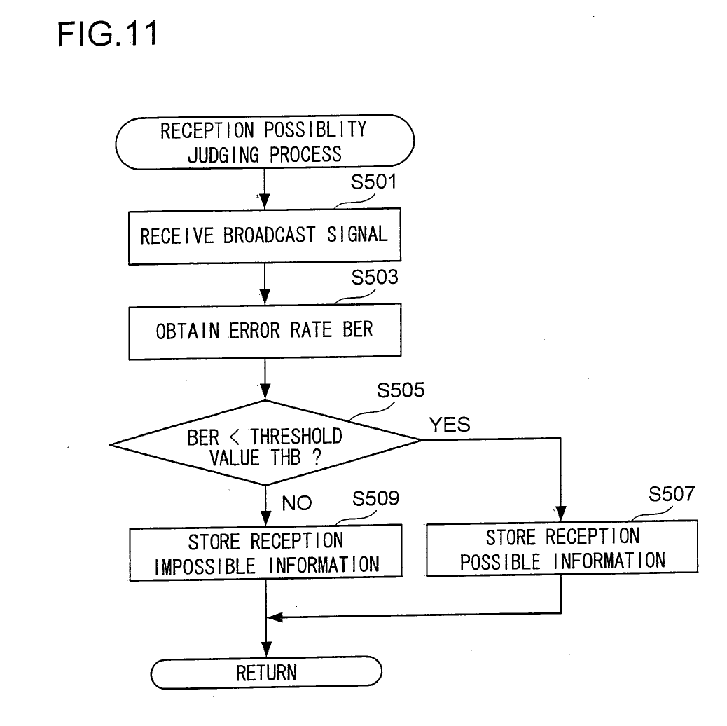

FIG. 11 is a detailed flowchart to show an example of the reception possibility judging process executed in step S115 of the flowchart shown in FIG. 5. First, the second intensity obtaining unit 116 receives a broadcast signal through the receiving unit 15 (S501). Then, the second intensity obtaining unit 116 obtains a bit error rate BER (S503). Subsequently, the direction setting unit 117 judges whether the bit error rate BER obtained in step S503 is less than a preset predetermined threshold value THB (S505).

If it is judged that the bit error rate BER is less than the threshold value THB (YES in S505), the direction setting unit 117 judges that the reception is possible, the information indicating that the reception is possible is stored in the setting direction storage unit 123 (S507), and then the process is returned. If it is judged that the bit error rate BER is not less than the threshold value THB (NO in S505), the direction setting unit 117 judges that the reception is impossible, the information indicating that the reception is impossible is stored in the setting direction storage unit 123 (S509), and the process is returned.

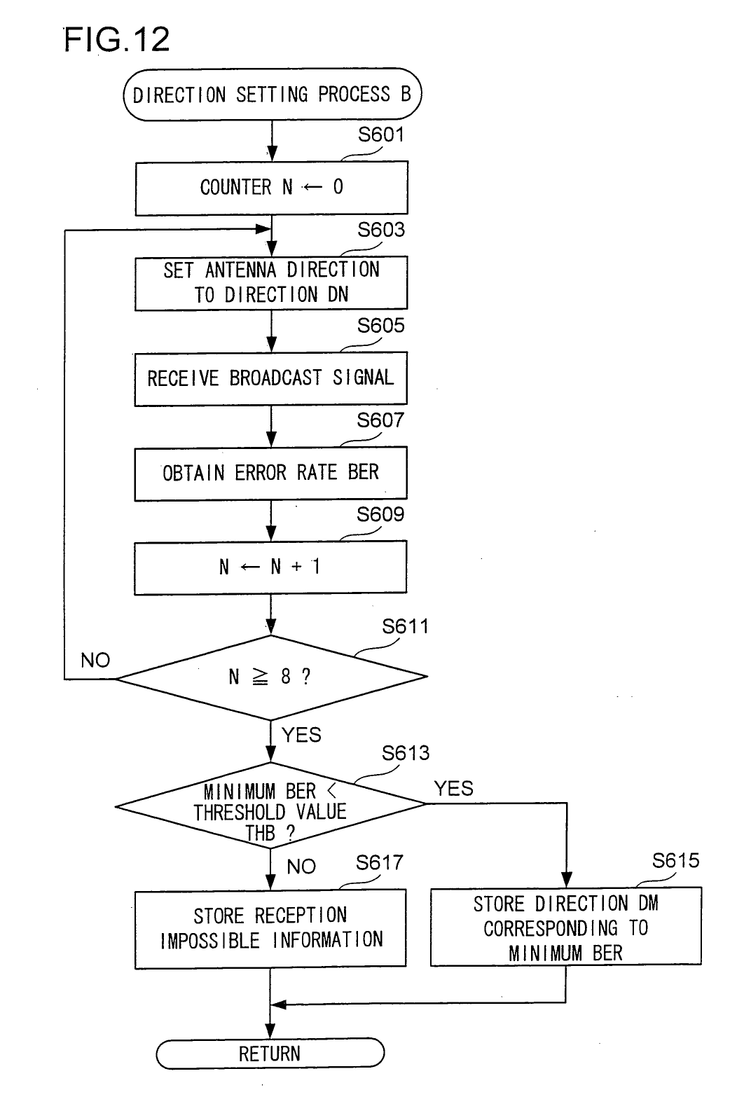

FIG. 12 is a detailed flowchart to show an example of the direction setting process B executed in step S119 of the flowchart shown in FIG. 5. First, the second intensity obtaining unit 116 sets the counter N for counting the direction of the antenna to an initial value “0” (S601). Then, the second intensity obtaining unit 116 sets the direction of the antenna connected to the antenna unit 151 to the direction DN (in this case, N represents any value of 0 to 7=the value of the counter N) (S603). Subsequently, the second intensity obtaining unit 116 receives a broadcast signal through the receiving unit 15 (S605). Subsequently, the second intensity obtaining unit 116 obtains a bit error rate BER (S607). Then, the second intensity obtaining unit 116 increments the value of the counter N by only 1 (S609), and it is judged whether the value of the counter N is equal to 8 or more (S611). If it is judged that the value of the counter N is not equal to 8 or more (=7 or less) (NO in S611), the process is returned to the step S603, and the process of the step S603 and the subsequent steps is repetitively executed.

If it is judged that the value of the counter N is equal to 8 or more (YES in S611), the direction setting unit 117 judges whether the minimum bit error rate BER out of the eight bit error rates BER obtained in step S607 is less than the preset predetermined threshold value THB (S613). If it is judged that the minimum bit error rate BER is not more than the threshold value THB (YES in S613), the information indicating that the reception is possible and the direction DM (M=any value of 0 to 7) corresponding to the minimum bit error rate BER are stored in the setting direction storage unit 123 by the direction setting unit 117 (S615), and then the process is returned. If it is judged that the minimum bit error rate BER is above the threshold value THB (NO in S613), the direction setting unit 117 judges that the reception is impossible, the information indicating that the reception is impossible is stored in the setting direction storage unit 123 (S617), and the process is returned.

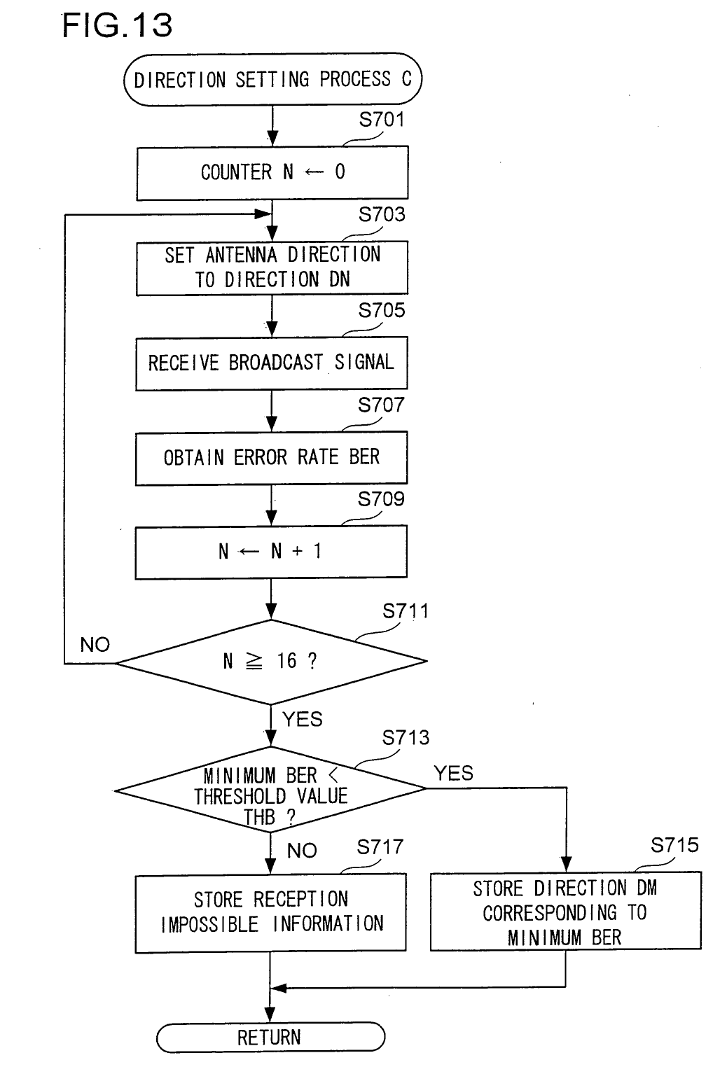

FIG. 13 is a detailed flowchart to show an example of the direction setting process C executed in step S121 of the flowchart shown in FIG. 5. First, the second intensity obtaining unit 116 sets the counter N for counting the direction of the antenna to an initial value “0” (S701). Then, the second intensity obtaining unit 116 sets the direction of the antenna connected to the antenna unit 151 to the direction DN (in this case, N represents any value of 0 to 15=the value of the counter N) (S703). Subsequently, the second intensity obtaining unit 116 receives a broadcast signal through the receiving unit 15 (S705). Subsequently, the second intensity obtaining unit 116 obtains the bit error rate BER (S707). Then, the second intensity obtaining unit 116 increments the value of the counter N by only 1 (S709), and it is judged whether the value of the counter N is equal to 16 or more (S711). If it is judged that the value of the counter N is not above 16 (=15 or less) (NO in S711), the process is returned to step S703, and the process of the step S703 and the subsequent steps is repetitively executed.

When it is judged that the value of the counter N is equal to 16 or more (YES in S711), the direction setting unit 117 judges whether the minimum bit error rate BER output of the sixteen bit errors rate BER obtained in step S707 is less than the preset predetermined threshold value THB (S713). If it is judged that the minimum bit error rate BER is not more than the threshold value THB (YES in S713), the information indicating that the reception is possible and the direction DM (M=any value of 0 to 15) are stored in the setting direction storage unit 123 by the direction setting unit 117 (S715), and the process is returned. If it is judged that the minimum bit error rate BER is above the threshold value THB (NO in S713), the direction setting unit 117 judges that the reception is impossible, and the information indicating that the reception is impossible is stored in the setting direction storage unit 123 (S717), and the process is returned.

As described above, the antenna connected to the antenna unit 151 is set in preset a plurality of (in this case, sixteen: see FIG. 4A) directions, and the reception intensity is obtained for every set direction. On the basis of the reception intensity obtained in each direction, it is judged whether the antenna connected to the antenna unit 151 is the smart antenna or not. If it is judged that the connected antenna is the smart antenna, it is judged on the basis of the obtained reception intensity in each direction whether the connected antenna is a bi directional antenna having directivities in two directions intersecting to each other at substantially 180 degree (see FIG. 4B) or a unidirectional antenna having directivity in only one direction (see FIG. 4C). Therefore, the type of the connected antenna (=the smart antenna or not and also a bi directional antenna or not) can be identified.

That is, it is judged whether the connected antenna is a bi directional antenna having directivities in two directions intersecting to each other at substantially 180 degree or a unidirectional antenna having directivity in only one direction, so that the optimum reception direction can be efficiently determined. That is, if it is judged that the connected antenna is a bi directional antenna, the optimum reception direction can be determined from the reception intensities in the eight directions comprising the directions D0 to D7 shown in FIG. 4A (see FIG. 12).

Furthermore, a prescribed channel which is contained in preset a plurality of channels (in this case, 68 channels having channel numbers of “2” to “69”) and receives a television broadcast signal through the connected antenna is successively set, the reception intensity in each channel is obtained, and it is judged whether the set prescribed channel is a channel belonging to the UHF band or a channel belonging to the VHF band. The channels are sectioned into channels judged as belonging to the UHF band and channels judged as belonging to the VHF band, that is, the sixty eight channels are classified into a UHF band channel group comprising the channels belonging to the UHF band and a VHF band channel group comprising the channels belonging to the VHF band, and it is judged for every channel group whether the connected antenna is the smart antenna or not and whether the connected antenna is a bi directional antenna or not, whereby the type of the connected antenna (=a smart antenna or not, and also a bi directional antenna or not) can be more accurately identified.

That is, at least one of whether the connected antenna is the smart antenna and whether the connected antenna is a bi directional antenna is judged for every channel group (i.e., individually for each of the UHF band channel group and the VHF band channel group). Therefore, there may be a case where the judgment result is different between the UHF band channel group and the VHF band channel group, thus the type of the connected antenna (=a smart antenna or not and also a bi directional antenna or not) can be more accurately identified.

Furthermore, the connected antenna is set in four directions intersecting to one another at every 90 degree (in this case, the directions D0, D4, D8, D12 shown in FIG. 4A), and the reception intensity in each set direction is obtained. On the basis of the maximum reception intensity (in this case, the parameter EM), the reception intensity (in this case, the parameter ER) in the direction (for example, the direction D4) intersecting to the maximum reception intensity providing direction (for example, the direction D0) at 90 degree and the reception intensity (in this case, the parameter EI) in the direction (for example, the direction D8) intersecting to the maximum reception intensity providing direction at 180 degree out of the reception intensities obtained in the respective directions, it is judged whether the connected antenna is the smart antenna or not and also the connected antenna is a bi directional antenna or not (see FIGS. 9 and 10). Therefore, the type of the connected antenna (=at least one of the judgment concerning the smart antenna or not and the judgment concerning a bi directional antenna or not) can be simply and accurately identified.

That is, on the basis of the maximum reception intensity (in this case, the parameter EM), the reception intensity (in this case, the parameter ER) in the direction intersecting to the maximum reception intensity providing direction at 90 degree and the reception intensity (in this case, the parameter EI) in the direction intersecting to the maximum reception intensity providing direction at 180 degree, it is judged whether the connected antenna is the smart antenna or not and also the connected antenna is a bi directional antenna or not. Accordingly, for example when the maximum reception intensity (in this case, the parameter EM) and the reception intensity in the direction intersecting to the maximum reception intensity providing direction at 90 degree (in this case, the parameter ER) have substantially the same value, it is judged that the connected antenna is not the smart antenna. On the other hand, when the maximum reception intensity (in this case, the parameter EM) and the reception intensity in the direction intersecting to the maximum reception intensity providing direction at 180 degree (in this case, the parameter EI) have substantially the same value, it is judged that the connected antenna is a bi directional antenna. Therefore, the type of the connected antenna (=the smart antenna or not and a bi directional antenna or not) can be simply and accurately identified.

In addition, the judgment values V1 to V3, U1 to U3 are renewed in accordance with the reception state in each channel (the values of the parameters EM, ER, EI) as shown in FIGS. 9 and 10, and as shown in FIGS. 6 and 7, it is judged on the basis of the judgment values V1 to V3, U1 to U3 whether the connected antenna is the smart antenna or not and also whether the connected antenna is a bi directional antenna or not. Therefore, the type of the connected antenna (=the smart antenna or not and a bi directional antenna or not) can be simply and accurately identified.

The present invention may be applied in the following styles.

(A) In this embodiment, the broadcast receiving apparatus is a digital broadcasting receiver 1. However, it may be a broadcasting receiving apparatus for receiving analog broadcast, or a broadcast receiving apparatus for receiving analog broadcast and digital broadcast. When the broadcast receiving apparatus receives analog broadcast, the reception intensity may be estimated by using S/N ratio in place of the bit error rate BER.

(B) In this embodiment, the monitor is the display 183 disposed in the digital broadcasting receiver 1, however, the monitor may be structured as a separate apparatus separated from the digital broadcasting receiver 1. For example, the monitor may be LCD (Liquid Crystal Display) or the like disposed in a personal computer or the like.

(C) In this embodiment, the MPU 11 functions as function parts such as the channel setting unit 111, the channel judging unit 112, the first intensity obtaining unit 113, the judgment value determining unit 114, the antenna judging unit 115, the second intensity obtaining unit 116, the direction setting unit 117 or the like. However, at least one of the function parts of the channel setting unit 111, the channel judging unit 112, the first intensity obtaining unit 113, the judgment value determining unit 114, the antenna judging unit 115, the second intensity obtaining unit 116 and the direction setting unit 117 may be structured by a hardware such as a circuit or the like.

(D) In this embodiment, the channels are sectioned (classified) into the UHF band channel group and the VHF band channel group, and the antenna judging unit 115 makes the judgment individually (separately) for every each channel group. However, the antenna judging unit 115 may make the judgment while the channels are not sectioned (classified) as described above. Furthermore, the antenna judging unit 115 may make the judgment for only any one of the channel groups. In this case, the process is simplified.

(E) In this embodiment, the judgment value determining unit 114 determines the additional values (for example, the additional values A11, S12) by using threshold values of two steps (for example, the threshold values TH11, TH12) to renew the judgment values V1 to V3, U1 to U3 (see FIGS. 9 and 10). The judgment value determining unit 114 may determine the additional values by using a threshold value of one step (for example, the threshold value TH11) to renew the judgment values V1 to V3, U1 to U3, or may determine the additional values by using threshold values of three or more steps to renew the judgment values V1 to V3, U1 to U3. In the former case, the process can be simplified, and in the latter case, the judgment can be more accurately made.

What is claimed is:

1. A broadcasting receiving apparatus to which a smart antenna as an antenna having a changeable directivity direction is connectable and which can receive television broadcast through the connected antenna and output the received television broadcast onto a monitor, comprising:
an intensity obtaining unit for setting the connected antenna to a plurality of preset directions and obtaining reception intensity for every set direction;
a first judging unit for judging on the basis of the reception intensity in each direction obtained by the intensity obtaining unit whether the connected antenna is the smart antenna or not; and
a second judging unit for judging on the basis of the reception intensity in each direction obtained by the intensity obtaining unit whether the connected antenna is a bidirectional antenna having directivity in two directions intersecting to each other at substantially 180 degree or a unidirectional antenna having directivity in only one direction when it is judged by the first judging unit that the connected antenna is the smart antenna.

2. The broadcasting receiving apparatus according to claim 1 further comprising:
a channel setting unit for setting a prescribed channel for receiving through the connected antenna from a plurality of preset channels; and
a channel judging unit for judging whether the prescribed channel set by the channel setting unit is a channel belonging to an UHF (Ultra High Frequency) band or a channel belonging to a VHF (Very High Frequency) band, wherein
the intensity obtaining unit makes the channel setting unit successively set one of the plurality of channels and obtains the reception intensity in each channel of the plurality of channels, and
at least one of the first judging unit and the second judging unit sections the channels into a UHF band channel group and a VHF band channel group that respectively comprise channels judged as belonging to the UHF band and channels judged as belonging to the VHF band by the channel judging unit to make a judgment for every channel group.

3. The broadcasting receiving apparatus according to claim 1, wherein
the intensity obtaining unit sets the connected antenna in four directions intersecting to one another at every 90 degree and obtains the reception intensity in each set direction, and
at least one of the first judging unit and the second judging unit makes the judgment on the basis of the maximum reception intensity, the reception intensity in a direction intersecting to the maximum reception intensity obtaining direction at 90 degree and the reception intensity in a direction intersecting to the maximum reception intensity obtaining direction at 180 degree out of the reception intensities in the respective obtained directions by the intensity obtaining unit.

4. The broadcasting receiving apparatus according to claim 1, wherein
the intensity obtaining unit sets the connected antenna in four directions intersecting to one another at every 90 degree and obtains the reception intensity in each set direction, and
at least one of the first judging unit and the second judging unit makes the judgment on the basis of the maximum reception intensity, the reception intensity in a direction intersecting to the maximum reception intensity obtaining direction at 90 degree and the reception intensity in a direction intersecting to the maximum reception intensity obtaining direction at 180 degree out of the reception intensities in the respective obtained directions by the intensity obtaining unit.

5. A broadcasting receiving apparatus to which a smart antenna as an antenna having a changeable directivity direction is connectable and which can receive television broadcast through the connected antenna and output the received television broadcast onto a monitor, comprising:
an intensity obtaining unit for setting the connected antenna to a plurality of preset directions and obtaining reception intensity for every set direction;
a first judging unit for judging on the basis of the reception intensity in each direction obtained by the intensity obtaining unit whether the connected antenna is the smart antenna or not;
a second judging unit for judging on the basis of the reception intensity in each direction obtained by the intensity obtaining unit whether the connected antenna is a bidirectional antenna having directivity in two directions intersecting to each other at substantially 180 degree or a unidirectional antenna having directivity in only one direction when it is judged by the first judging unit that the connected antenna is the smart antenna;
a channel setting unit for setting a prescribed channel for receiving through the connected antenna from a plurality of preset channels; and
a channel judging unit for judging whether the prescribed channel set by the channel setting unit is a channel belonging to an UHF (Ultra High Frequency) band or a channel belonging to a VHF (Very High Frequency) band, wherein
the intensity obtaining unit makes the channel setting unit successively set one of the plurality of channels, obtains the reception intensity in each channel of the plurality of channels, and sets the connected antenna in four directions intersecting to one another at every 90 degree and obtains the reception intensity in each set direction,
the first judging unit and the second judging unit sections the channels into a UHF band channel group and a VHF band channel group that respectively comprise channels judged as belonging to the UHF band and channels judged as belonging to the VHF band by the channel judging unit to make a judgment for every channel group, and makes the judgment on the basis of the maximum reception intensity, the reception intensity in a direction intersecting to the maximum reception intensity obtaining direction at 90 degree and the reception intensity in a direction intersecting to the maximum reception intensity obtaining direction at 180 degree out of the reception intensities in the respective obtained directions by the intensity obtaining unit.
